(19) United States
(12) Patent Application Publication
(10) Pub. No.: US 2026/0118916 A1
(43) Pub. Date: Apr. 30, 2026

(54) WINDOW AND DISPLAY DEVICE INCLUDING THE SAME

(71) Applicant: Samsung Display Co., Ltd., Yongin-si (KR)

(72) Inventors: SU-HYOUNG KANG, Yongin-si (KR); SANGDUK LEE, Yongin-si (KR); Yunyoung LEE, Yongin-si (KR); Jun Yeub LEE, Yongin-si (KR); HOIKWAN LEE, Yongin-si (KR)

(21) Appl. No.: 19/348,389

(22) Filed: Oct. 2, 2025

(30) Foreign Application Priority Data
Oct. 24, 2024 (KR) 10-2024-0146907

(51) Int. Cl. G06F 1/16

(52) U.S. Cl. CPC G06F 1/1656; G06F 1/1652

(57) ABSTRACT

Provided is a window including a cover layer, the cover layer including a base resin including at least one of a siloxane-epoxy-based compound, an epoxy (meth)acrylate-based compound, or a urethane (meth)acrylate-based compound, a siloxane functionalized polyol, a diglycidyl ether compound, a photo initiator, and a sensitizer.

### CROSS-REFERENCE TO RELATED APPLICATION

The present application claims priority to, and the benefit of, Korean Patent Application No. 10-2024-0146907, filed on Oct. 24, 2024, in the Korean Intellectual Property Office, the entire disclosure of which is incorporated herein by reference.

### BACKGROUND

The present disclosure herein relates to a window having excellent mechanical properties, and a display device including the same.

Display devices are used for providing image information to users in various multimedia apparatuses, such as televisions, mobile phones, tablets, and game consoles. Recently, flexible display devices in various forms, which are capable of being folded, or bent, have been developed. The flexible display devices may be folded, rolled, or bent into various shapes, thereby having easily portable characteristics.

The flexible display devices may include a display panel and a window that can be folded or bent. However, the window of the flexible display device may be deformed by a folded or bent operation, or easily damaged by external shock.

### SUMMARY

The present disclosure provides a window having folding reliability and durability.

The present disclosure also provides a display device including a window having improvements in folding reliability and durability.

One or more embodiments of the present disclosure provide a window including a cover layer, the cover layer including a base resin including at least one of a siloxane-epoxy-based compound, an epoxy (meth)acrylate-based compound, or a urethane (meth)acrylate-based compound, a siloxane functionalized polyol, a diglycidyl ether compound, a photo initiator, and a sensitizer.

The cover layer may have a thickness of about 30 μm to about 75 μm.

The cover layer may include about 70 wt % to about 80 wt % of the base resin, about 5 wt % to about 10 wt % of the siloxane functionalized polyol, about 1 wt % to about 5 wt % of the diglycidyl ether compound, about 3 wt % to about 5 wt % of the photo initiator, and about 1 wt % to about 5 wt % of the sensitizer.

The base resin may be a siloxane-epoxy-based compound.

The siloxane functionalized polyol may include a caprolactone polyol.

The photo initiator may include at least one of an iodine salt, a sulfonium salt, a tropylium salt, an acetophenone-based compound, a sulfonium-based compound, a benzophenone-based compound, or an organic halide.

The sensitizer may be a thioxanthone-based compound.

The cover layer may have a modulus of about 500 Mpa to about 1.5 Gpa.

The window may further include a base layer below the cover layer, and including a polyethylene terephthalate film.

The base layer may have a thickness of about 20 μm to about 50 μm.

The window may further include a protecting layer above the cover layer, and a protective adhesion layer between the protecting layer and the cover layer.

The window may further include a functional layer above the cover layer, including a fluorine-containing compound, and having a thickness of about 10 μm or less.

One or more embodiments of the present disclosure provide a display device including a display module, and a window above the display module, and including a cover layer, the cover layer including a base resin including at least one of a siloxane-epoxy-based compound, an epoxy (meth)acrylate-based compound, or a urethane (meth)acrylate-based compound, a siloxane functionalized polyol, a diglycidyl ether compound, a photo initiator, and a sensitizer.

The window may further include a base layer between the display module and the cover layer, and including a polymer film.

The cover layer may be directly on the base layer.

The display device may further include a window adhesion layer between the display module and the window, wherein the base layer is directly on the window adhesion layer, and wherein the cover layer is directly on the base layer.

The display module may include a base substrate, a circuit layer above the base substrate, a light-emitting element layer above the circuit layer, an encapsulation layer above the light-emitting element layer, and an optical layer above the encapsulation layer, and including a polarizing layer or color filter layer.

The cover layer may be directly on the optical layer.

The display device may further include a window adhesion layer between the optical layer and the cover layer, wherein the cover layer is directly on the window adhesion layer.

The display device may further include at least one folding part that is folded with respect to a folding axis extending to one direction.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1A is a perspective view illustrating an unfolded state of a display device according to one or more embodiments of the present disclosure;

FIG. 1B is a perspective view showing an inner-folding process of the display device illustrated in FIG. 1A;

FIG. 1C is a perspective view showing an outer-folding process of the display device illustrated in FIG. 1A;

FIG. 2A is a perspective view illustrating an unfolded state of a display device according to one or more embodiments of the present disclosure;

FIG. 2B is a perspective view showing an inner-folding process of the display device illustrated in FIG. 2A;

FIG. 2C is a perspective view showing an outer-folding process of the display device illustrated in FIG. 2A;

FIG. 3 is an exploded perspective view of a display device according to one or more embodiments of the present disclosure;

FIG. 4 is a cross-sectional view of a display device according to one or more embodiments of the present disclosure;

FIG. 5 is a cross-sectional view of a display module according to one or more embodiments of the present disclosure;

FIG. 6A to FIG. 6C are cross-sectional views illustrating portions of configurations of a display device according to one or more embodiments of the present disclosure; and

FIG. 7A to FIG. 7C are cross-sectional views illustrating portions of configurations of a display device according to one or more embodiments.

FIG. 8 is a block diagram of an electronic device according to an embodiment.

FIG. 9 is schematic views of electronic devices according to various embodiments.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result of, for example, manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of elements, layers, or regions, but are to include deviations in shapes that result from, for instance, manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component.

In addition, in the present specification, when a portion of a layer, a film, an area, a plate, or the like is formed on another portion, a forming direction is not limited to an upper direction but includes forming the portion on a side surface or in a lower direction. On the contrary, when a portion of a layer, a film, an area, a plate, or the like is formed “under” another portion, this includes not only a case where the portion is “directly beneath” another portion but also a case where there is further another portion between the portion and another portion. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XY, YZ, and XZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, a window according to one or more embodiments of the present disclosure and a display device accosting to one or more embodiments will be described with reference to the drawings.

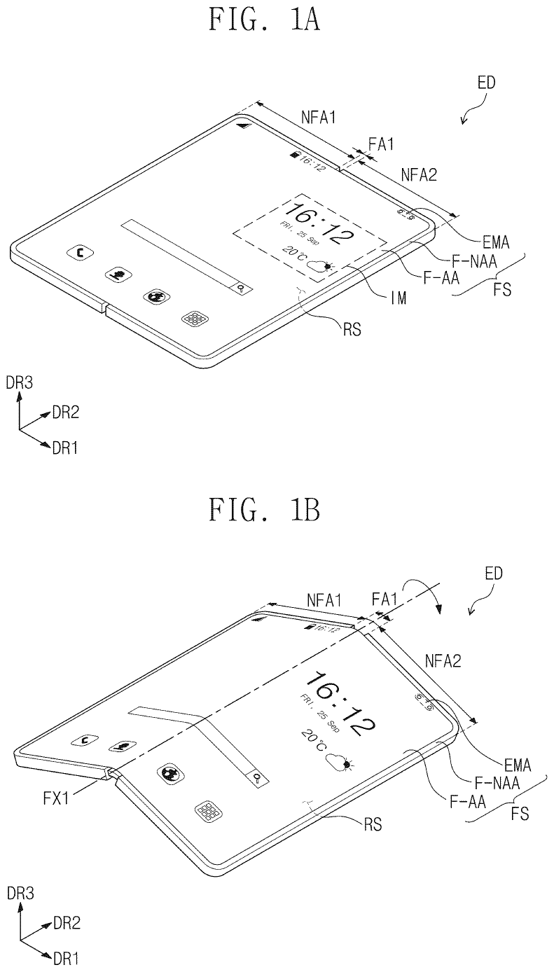

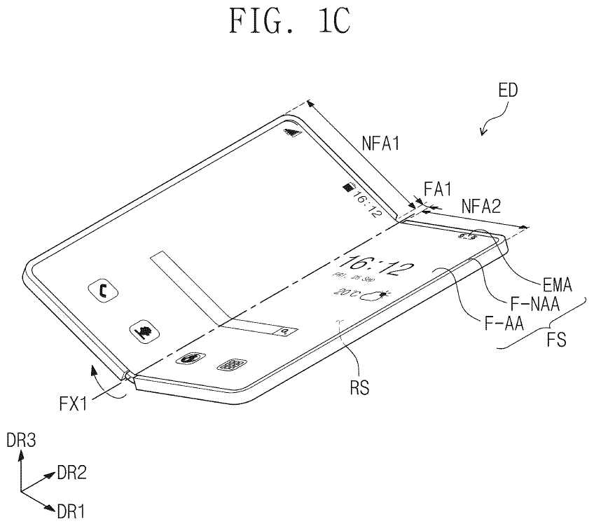

FIG. 1A is a perspective view illustrating an unfolded state of a display device according to one or more embodiments of the present disclosure. FIG. 1B is a perspective view showing an inner-folding process of the display device illustrated in FIG. 1A. FIG. 1C is a perspective view showing an outer-folding process of the display device illustrated in FIG. 1A.

A display device ED according to one or more embodiments may be a device activated in response to an electrical signal. For example, the display device ED may be a mobile phone, a tablet, a car navigation, a game console, or a wearable device, but one or more embodiments of the present disclosure is not limited thereto. In FIG. 1A and the like in the specification of the present disclosure, the display device ED is shown as a mobile phone.

Referring to FIG. 1A to FIG. 1C, the display device ED according to one or more embodiments may include a first display surface FS defined by a first direction DR1, and a second direction DR2 crossing the first direction DR1. The display device ED may provide an image to a user through the first display surface FS. The display device ED according to one or more embodiments may display an image IM to the first display surface FS parallel to each of the first direction DR1 and the second direction DR2 toward a third direction DR3. In the present specification, on the basis of a direction to which the image IM is displayed, a front surface (or top surface) and a rear surface (or bottom surface) of each component may be defined. The front surface and the rear surface may be opposite in the third direction DR3, and normal directions of each of the front surface and the rear surface may be parallel to the third direction DR3.

The display device ED according to one or more embodiments may include a first display surface FS and a second display surface RS. The first display surface FS may include an active region F-AA and a peripheral region F-NAA. The active region F-AA may include an electronic module region EMA. The second display surface RS may be defined as a surface opposite to at least a portion of the first surface FS. That is, the second display surface RS may be defined as a portion of the rear surface of the display device ED.

The display device ED according to one or more embodiments may detect an external input applied from the outside. The external inputs may include diverse types of inputs provided from the outside the display device ED. For example, the external input may include an external input applied to the display device ED at close range or a distance (e.g., hovering) as well as a touch by a body part, such as a user's hand. In addition, the external input may have various forms, such as force, pressure, temperature, light.

In FIG. 1A and the following drawings, the first direction DR1 to the third direction DR3 are illustrated, but directions indicated by the first to third directions DR1, DR2, and DR3 described in the present specification are relative concepts that may be reoriented into other directions.

The active region F-AA of the display device ED may be a region activated in response to electrical signals. The display device ED according to one or more embodiments may display an image IM through the active region F-AA. In addition, in the active region F-AA, various types of external inputs may be detected. The peripheral region F-NAA is adjacent to the active region F-AA. The peripheral region F-NAA may have a color (e.g., predetermined color). The peripheral region F-NAA may surround the active region F-AA. Accordingly, a shape of the active region may be defined by the peripheral region F-NAA. However, this is only illustrative purposes, the peripheral region F-NAA may be located adjacent to one side of the active region F-AA, or may be omitted. The display device ED according to one or more embodiments of the present disclosure may include an active region having various shapes, but is not limited to any one embodiment.

The display device ED may include a folding region FA1, and non-folding regions NFA1 and NFA2. In one or more embodiments, the non-folding regions NFA1 and NFA2 may be located adjacent to the folding region FA1, with the folding region FA1 therebetween. The display device ED according to one or more embodiments may include a first non-folding region NFA1 and a second non-folding region NFA2 located to be spaced apart from each other along the first direction DR1 direction with the folding region FA1 therebetween. For example, the first non-folding region NFA1 may be located on one side of the folding region FA1 along the first direction DR1, and the second non-folding region NFA2 may be located on another side of the folding region FA1 along the first direction DR1.

In FIG. 1A to FIG. 1C, the display device ED according to one or more embodiments including one folding region FA1 is illustrated, but one or more embodiments of the present disclosure is not limited thereto, and a plurality of folding regions may be defined in the display device ED. For example, a display device according to one or more embodiments may include two or more folding regions, and may include three or more non-folding regions, which are located with each of the folding regions therebetween.

Referring to FIG. 1B, the display device ED according to one or more embodiments may be folded with respect to a first folding axis FX1. The first folding axis FX1 is a virtual axis extending to the second direction DR2 and may be parallel to a long side direction of the display device ED. The first folding axis FX1 may extend on the first display surface FS along the second direction DR2.

The display device ED may be transformed, by being folded with respect to the first axis FX1, into an in-folded state in which one region overlapping the first non-folding region NFA1 faces another region overlapping the second non-folding region NFA2 in the first display surface FS.

The second display surface RS in the display device ED according to one or more embodiments may be viewed to the user in the in-folded state. The second display surface RS may further include an electronic module region in which an electronic module including various components is located, and is not limited to any one embodiment.

Referring to FIG. 1C, the display device ED according to one or more embodiments may be transformed into an out-folded state in which, by being folded with respect to the first axis FX1, into an out-folded state in which one region overlapping the first non-folding region NFA1 faces another region overlapping the second non-folding region NFA2 in the second display surface RS.

However, one or more embodiments of the present disclosure is not limited thereto. The display device may be folded with respect to a plurality of folding axes such that each portion of the first display surface FS and the second display surface RS faces, and the number of folding axes and the number of corresponding non-folding regions are not particularly limited.

In the electronic module region EMA, various electronic modules may be located. For example, the electronic modules may include at least one among a camera, a speaker, a light-detecting sensor, and/or a heat-detecting sensor. The electronic module region EMA may detect an external object that is received through the first or second display surfaces FS and RS, or may provide audio signals, such as voices to the outside through the first or second display surfaces FS and RS. The electronic module may include a plurality of components, but is not limited to any one embodiment.

The electronic module EMA may be surrounded by the active region F-AA and the peripheral region F-NAA. However, one or more embodiments of the present disclosure is not limited thereto, and the electronic module region EMA may be located in the active region F-AA, and is not limited to any one embodiment.

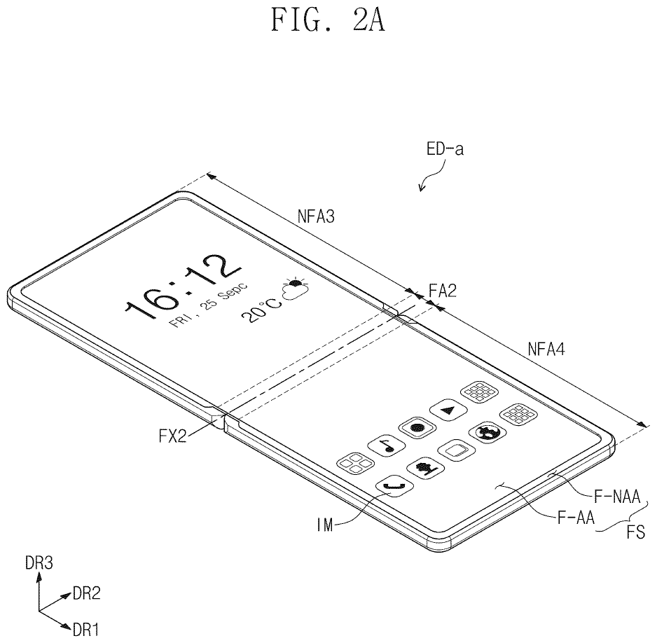

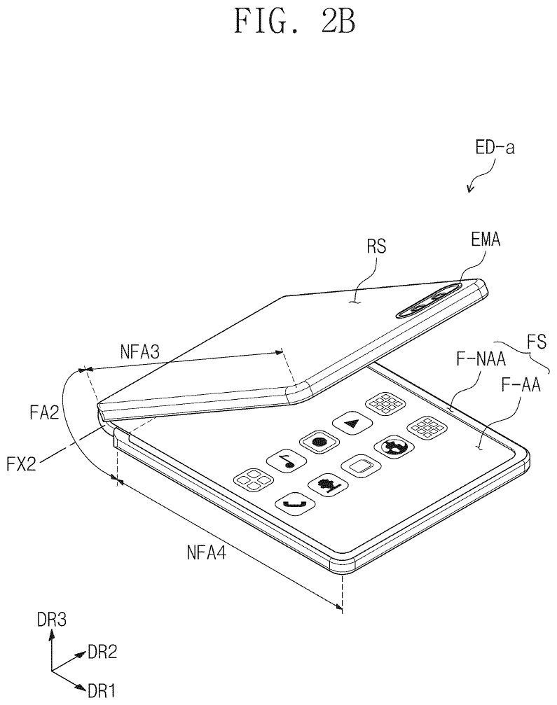

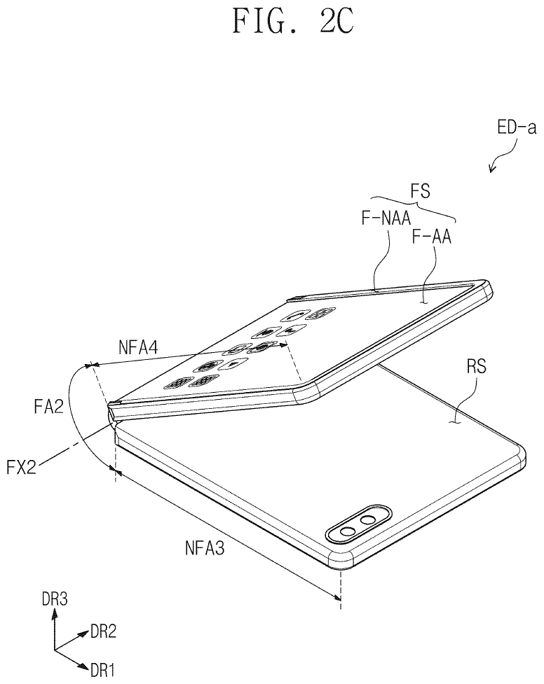

FIG. 2A is a perspective view illustrating an unfolded state of a display device according to one or more embodiments. FIG. 2B is a perspective view showing an inner-folding process of the display device illustrated in FIG. 2A. FIG. 2C is a perspective view showing an outer-folding process of the display device illustrated in FIG. 2A.

A display device ED-a according to one or more embodiments may be folded with respect to the second folding axis FX2 extending to one direction that is parallel to the second direction DR2. FIG. 2B shows a case where the extending direction of the second folding axis FX2 is parallel to an extending direction of a short side of the display device ED-a. However, one or more embodiments of the present disclosure is not limited thereto.

The display device ED-a according to one or more embodiments may include at least one folding region FA2, and non-folding regions NFA3 and NFA4 adjacent to the folding region FA2. The non-folding regions NFA3 and NFA4 may be located to be spaced apart from each other with the folding region FA2 therebetween.

The folding region FA2 has curvature (e.g., predetermined curvature) and radius of curvature. In one or more embodiments, the first non-folding region NFA3 and the second non-folding region NFA4 may face each other, and the display device ED-a may be in-folded such that a display surface FS is unexposed to the outside. In addition, referring to FIG. 2C, in one or more embodiments, the display device ED-a may be out-folded such that the first display surface FS is exposed to the outside.

The display device ED-a may include a second display surface RS and the second display RS may be defined as a surface which faces at least a portion of the first display surface FS. The second display surface RS may include an electronic module region EMA which includes an electronic module including various components. In addition, an image or a video may be displayed in at least a portion of the second display surface RS.

In one or more embodiments, the first display surface FS of the display device ED-a may be viewed to the user in a non-folded state, and the second display surface RS may be viewed to the user in an in-folded state.

In one or more embodiments, the display devices ED and ED-a may be configured to alternately repeat an inner-folding or outer-folding operation after an unfolding operation, but one or more embodiments of the present disclosure is not limited thereto. In one or more embodiments, the display devices ED and ED-a may be configured to select any one among, non-folding operation, inner-folding operation, and outer-folding operation. In addition, when a plurality of folding regions is included, at least one folding direction among the plurality of folding regions may be different from folding directions of the other folding regions. For example, when including two folding regions, two non-folding regions with one folding regions therebetween may be folded by the inner-folding operation, and two non-folding regions with another folding region therebetween may be folded by the outer-folding operation.

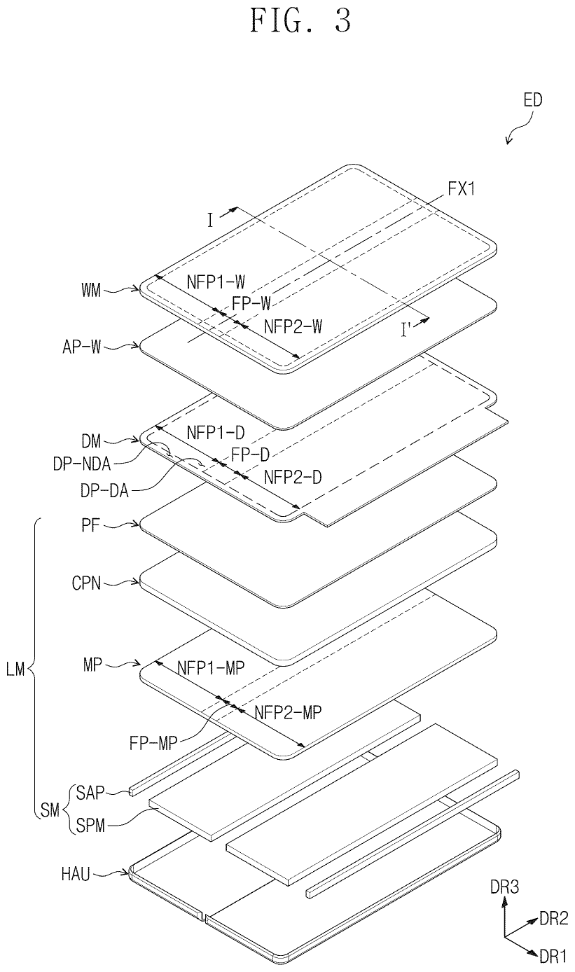

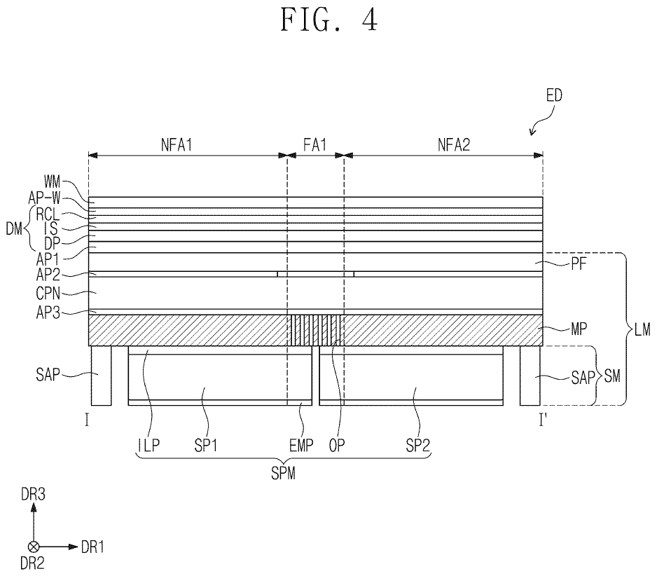

FIG. 3 is an exploded perspective view of a display device according to one or more embodiments, and FIG. 4 is a cross-sectional view of a display device according to one or more embodiments. FIG. 3 shows an exploded perspective view of the display device according to one or more embodiments, illustrated in FIG. 1A. FIG. 4 is a cross-sectional view illustrating a portion taken along the line I-I′ in FIG. 3.

FIG. 3, FIG. 4, etc., illustrate that the folding axis FX1 of the display device ED shown in FIG. 1A, etc., is parallel to the longitudinal side of the display device ED, but one or more embodiments of the present disclosure is not limited thereto, and descriptions which will be explained with reference to the following drawings may be also applicable to a case where the folding axis FX2 is parallel to the short side of the display device as illustrated in FIG. 2A, etc.

Referring to FIG. 3 and FIG. 4, the display device ED according to one or more embodiments may include a display module DM, and a window WM located on the display module DM (as used herein, “located on” may mean “above”). In addition, the display device ED according to one or more embodiments may further include a lower module LM located below the display module DM.

The display device ED according to one or more embodiments may further include a window adhesion layer AP-W located between the display module DM and the window WM. In the display device ED according to one or more embodiments, the window adhesion layer AP-W may be omitted. When the window adhesion layer AP-W is omitted, the window WM may be directly located on the display module DM.

The lower module LM may include a support plate MP located below the display module DM. The lower module LM may be named as a support member.

The display device ED may include a housing HAU accommodating the display module DM and the lower module LM. The housing HAU may adhere to the window WM. In one or more embodiments, the housing HAU may further include a hinge structure to facilitate folding or bending. The window WM may be a cover window located on the display module DM.

The display device ED according to one or more embodiments may include a window adhesion layer AP-W located between the display module DM and the window WM. The window adhesion layer AP-W may be an optically clear adhesive (OCA) film or an optically clear adhesive resin (OCR) layer. In one or more embodiments, the window adhesion layer AP-W may be omitted.

The window WM may cover an entire top surface of the display module DM. The window WM may have a shape corresponding to a shape of the display module DM.

The window WM may include a folding part FP-W and non-folding parts NFP1-W and NFP2-W. The first non-folding part NFP1-W and the second non-folding part NFP2-W of the window WM may be spaced apart from each other with the folding part therebetween in a first direction DR1. The folding part FP-W is a portion corresponding to the folding region FA1 (see FIG. 1A), and the non-folding parts NFP1-W and NFP2-W may be portions corresponding to the non-folding regions NFA1, and NFA2 (see FIG. 1A).

The window WM may include an optically transparent insulating material. The window WM may protect a display panel DP, an input sensor IS, etc. The window WM may be a cover window covering the top of the display module DM.

An image IM generated in the display panel DP may be provided to the user through the window WM. The window WM may provide a touch surface of the display device ED. In the display device ED including the folding region FA1, the window WM may be a flexible window that may be folded.

The window WM may be provided as a display surface, and a touch surface and may exhibit excellent optical characteristics. The window WM may have high transmittance of about 90% or more in a visible light region of about 380 nm to about 780 nm.

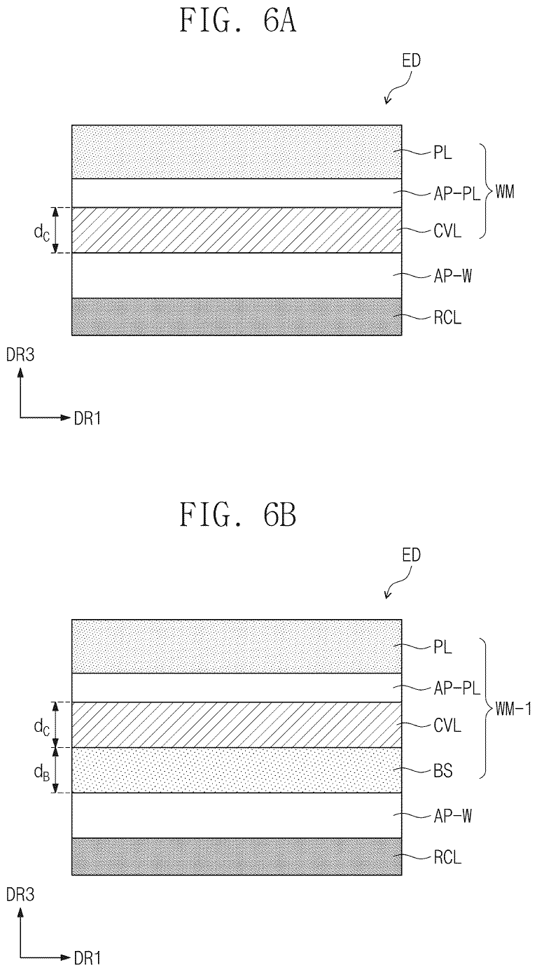

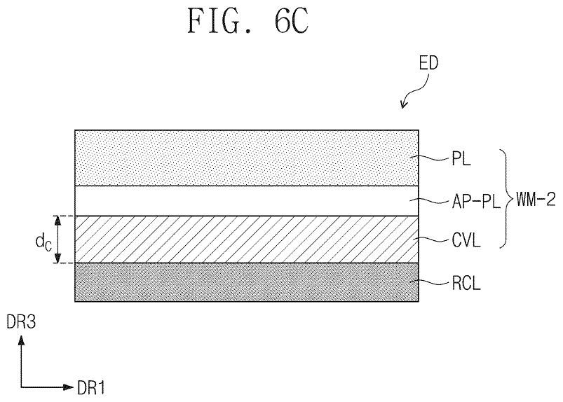

The window WM according to one or more embodiments may include a cover layer CVL (see FIG. 6A). Hereinafter, the window WM according to one or more embodiments will be described later in more detail.

The display module DM may display an image in response to electrical signals, and may send and receive information for external input. The display module DM may include a display region DP-DA and a non-display region DP-NDA. The display region DP-DA may be defined as a region that displays an image provided from the display module DM.

The non-display region DP-NDA is adjacent to the display region DP-DA. For example, the non-display region DP-NDA may surround the display region DP-DA (e.g., in plan view). However, this is only an example, and the non-display region DP-NDA may be defined in various shapes and is not limited to any one embodiment. According to one or more embodiments, the display region DP-DA of the display module DM may correspond to at least a portion of the active region F-AA (see FIG. 1A).

In one or more embodiments, the display module DM includes a display panel DP. The display panel DP may be a luminescent display panel, but is not particularly limited. For example, the display panel DP may be an organic luminescent display panel, or inorganic luminescent display panel. An emission layer of the organic luminescent display panel may include an organic luminescent material. An emission layer of the inorganic luminescent display panel may include a quantum dot, a quantum rod, etc.

The display module DM may further include an input sensor IS. The input sensor IS may be directly located on the display panel DP. The input sensor IS may include a plurality of detecting electrodes. The input sensor IS may detect external inputs using a self-captive or mutual-captive method. The input sensor IS may detect inputs by an active-type input device.

The input sensor IS may be directly provided on the display panel DP through continuous processes during manufacture of the display panel DP. However, one or more embodiments of the present disclosure is not limited thereto, and the input sensor IS may be manufactured as a different panel with the display panel DP and may be attached to the display panel DP by an adhesion layer, in one or more embodiments.

In addition, the display module DM may further include an optical layer RCL. The optical layer RCL may serve to decrease reflection for external light. For example, the optical layer RCL may include a polarizing layer or color filter layer. However, one or more embodiments of the present disclosure is not limited thereto, and the optical layer RCL may include optical members for improving display quality of the display device ED.

In one or more embodiments, the optical layer RCL may be directly located on the input sensor IS. In addition, when the input sensor IS is omitted in the display module DM, the optical layer RCL may be directly located on the display panel DP. However, one or more embodiments of the present disclosure is not limited thereto, and the optical layer RCL, may also be located on the display panel DP or on the input sensor IS using an additional adhesion member.

The display module DM may include a folding display part FP-D and a non-folding display parts NFP1-D, and NFP2-D. The folding display part FP-D may be a portion corresponding to the folding region FA1 (see FIG. 1A), and the non-folding display parts NFP1-D and NFP2-D may be portions corresponding to the non-folding regions NFA1 and NFA2 (see FIG. 1A).

The folding display part FP-D may be folded or bent with respect to the first folding axis FX1 (see FIGS. 1B and 1C). The display module DM may include the first non-folding display part NFP1-D and the second non-folding display part NFP2-D, and the first non-folding display part NFP1-D and the second non-folding display part NFP2-D may be spaced apart from each other with the folding display part FP-D therebetween.

In the display device ED according to one or more embodiments, the lower module LM may include a support plate MP. In addition, in one or more embodiments, the lower module LM may include at least one among a support module SM, a panel-protecting layer PF, and/or a buffer layer CPN. For example, the display device ED according to one or more embodiments may include a support plate MP, which is located below the display module DM, a panel-protecting layer PF and a buffer layer CPN, which are located between the support plate MP and the display module DM, and a support module SM, which is located below the support plate MP.

In one or more embodiments, the support plate MP may be located below the display module DM. The support plate MP may include a folding supporting part FP-MP and non-folding supporting parts NFP1-MP and NFP2-MP. The first non-folding supporting part NFP1-MP and the second non-folding supporting part NFP2-MP of the support plate MP may be spaced apart from each other with the folding supporting part FP-MP therebetween. The folding supporting part FP-MP may be a portion corresponding to the folding region FA1 (see FIG. 1A), and the non-folding supporting parts NFP1-MP and NFP2-MP may be portions corresponding to the non-folding regions NFA1, and NFA2 (see FIG. 1A).

Referring to FIG. 3 and FIG. 4, a panel-protecting layer PF may be located between the display module DM and the support plate MP. The panel-protecting layer PF may be a layer located below the display module DM to protect a rear surface of the display module DM. The panel-protecting layer PF may overlap the entire display module DM. The panel-protecting layer PF may include a polymer material. For example, the panel-protecting layer PF may be a polyimide film or a polyethylene terephthalate film. However, this is suggested as an example, and a material for the panel-protecting layer PF is not limited thereto.

The display device ED according to one or more embodiments may include a support module SM. The support module SM may include a support unit SPM and a filling portion SAP. The support unit SPM may be a portion overlapping most area of the display module DM. The filling portion SAP may be a portion located on outer side of the support unit SPM and overlapping an outer edge of the display module DM.

The support module SM may include support layers SP1 and SP2. The support layers SP1 and SP2 may include a first sub-support layer SP1 and a second sub-support layer SP2, which are spaced apart from each other in the first direction DR1. The first sub-support layer SP1 and the second sub-support layer SP2 may be spaced apart from each other at a portion corresponding to the first folding axis FX1 (see FIG. 1B and FIG. 1C). The support layers SP1 and SP2 may be spaced apart from each other in the folding region FA1 to be provided as the first sub-support layer SP1 and the second sub-support layer SP2, and thus folding or bending properties of the display device ED may be improved. In one or more embodiments, the support layers SP1 and SP2 may include components of a cushion layer and a lower support plate, which are stacked in a thickness direction.

In one or more embodiments, the lower support plate may include a metal material or a polymer material. For example, the lower support plate may include stainless steel, aluminum, copper, or an alloy thereof.

In one or more embodiments, the cushion layer may reduce or prevent the support plate MP from being dented and deformed due to external impact and force. The cushion layer may include an elastomer, such as sponge, foam, or urethane resin. In addition, the cushion layer may be formed including at least one among an arylate-based polymer, a urethane-based polymer, a silicon-based polymer, and/or an imide-based polymer. However, one or more embodiments of the present disclosure is not limited thereto. The cushion layer may be located under the support plate MP or under of the lower support plate, in one or more embodiments.

In addition, the support module SM may further include at least one among a shielding layer EMP and/or an interlayer adhesion layer ILP. The shielding layer EMP may be an electromagnetic wave-shielding layer or a heat dissipation layer. In addition, the shielding layer EMP may serve as an adhesion layer. The support module SM and the housing HAU may be adhered using the shielding layer.

The support module SM may further include an interlayer adhesion layer ILP located on the support layers SP1 and SP2. The interlayer adhesion layer ILP may attach the support plate MP and the support module SM. The interlayer adhesion layer ILP may be provided in a form of an adhesion resin layer or an adhesion tape. For example, the interlayer adhesion layer ILP may be a layer in which a portion overlapping the folding display part FP-D is removed. However, one or more embodiments of the present disclosure is not limited thereto, and the interlayer adhesion layer ILP may overlap the entire folding display part FP-D.

The filling portion SAP may be located on an outer edge of the support layers SP1 and SP2. The filling portion SAP may be located between the support plate MP and the housing HAU. The filling portion SAP may fill a space between the support plate MP and the housing HAU, and may fix the support plate MP.

Referring to FIG. 3 and FIG. 4, the display device ED according to one or more embodiments may include a buffer layer CPN in the lower module LM. The buffer layer CPN may serve as a thickness compensation layer compensating a thickness of the lower side of the display module DM, or as a support layer supporting the display module DM. Unlike what is illustrated, in one or more embodiments, the buffer layer CPN may be omitted.

In the display device ED according to one or more embodiments, a combination of components included in the lower module LM may vary depending on a size and a shape of the display device ED and operating properties of the display device ED.

In addition, the display device ED according to one or more embodiments may further include at least one adhesion layer AP1, AP2, or AP3. For example, the first adhesion layer AP1 may be located between the display module DM and the panel-protecting layer PF, the second adhesion layer AP2 may be located between the panel-protecting layer PF and the buffer layer CPN, and the third adhesion layer AP3 may be located between the support plate MP and the buffer layer CPN. At least one adhesion layer AP1, AP2, or AP3 may be an optically clear adhesive (OCA) film or optically clear adhesive resin (OCR) layer. However, one or more embodiments of the present disclosure is not limited thereto, and the at least one adhesion layer AP1, AP2, or AP3 may have low transmittance of about 80% or less.

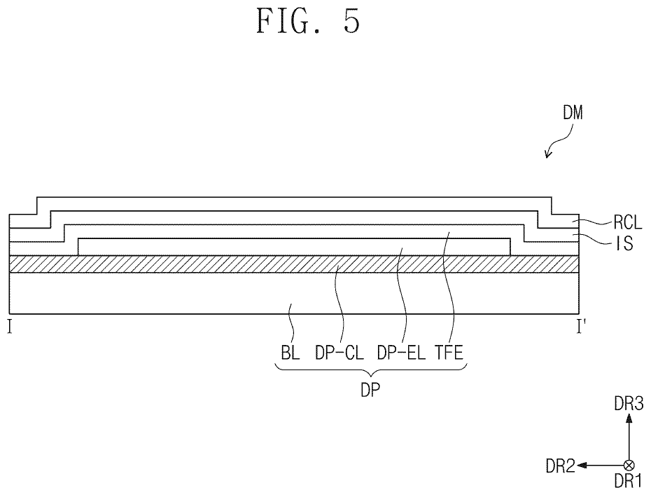

FIG. 5 is a cross-sectional view of the display module according to one or more embodiments of the present disclosure.

Referring to FIG. 5, the display module DM may include a display panel DP, an input sensor IS, and an optical layer RCL. The display panel DP may include a base substrate BL, a circuit layer DP-CL, a light-emitting element layer DP-EL, and an encapsulation layer TFE.

The base substrate BL may provide a base surface on which the circuit layer DP-CL is located. The base substrate BL may be a flexible substrate that may be bent, folded, or rolled. The base substrate BL may be a glass substrate, a metal substrate, a polymer substrate, etc. However, one or more embodiments of the present disclosure is not limited thereto, and the base substrate BL may be an inorganic layer, an organic layer, or a composite material layer.

The base substrate BL may have a single- or multi-layered structure. In one or more embodiments, the base substrate BL may have a multi-layered structure. For example, the base substrate BL may include a first synthetic resin layer, or a multi- or single-layered inorganic layer, a second synthetic resin layer located on the single- or multi-layered inorganic layer. The first and second synthetic resin layers may each include a polyimide-based resin, but are not particularly limited.

The circuit layer DP-CL may be located on the base substrate BL. The circuit layer DP-CL may include an insulation layer, a semiconductor pattern, a conductive pattern, signal lines, etc.

The light-emitting element layer DP-EL may be located on the circuit layer DP-CL. The light-emitting element layer DP-EL may include a light-emitting element. For example, the light-emitting element may include an organic luminous material, an inorganic luminous material, an organic-inorganic luminous material, a quantum dot, a quantum rod, a micro-LED, or a nano LED.

The encapsulation layer TFE may be located on the light-emitting element layer DP-EL. The encapsulation layer TFE may protect the light-emitting element layer DP-EL from foreign substances, such as moisture, oxygen, and dust particles. The encapsulation layer TFE may include at least one inorganic layer. The encapsulation layer TFE may include a laminate structure of inorganic layer/organic layer/inorganic layer.

The input sensor IS may be directly located on the display panel DP. The display panel DP and the input sensor IS may be formed through continuous processes. Herein, the term “directly located may mean that no intervening component is located between the input sensor IS and the display panel DP. That is, there may be no additional adhesion layer between the input sensor IS and the display panel DP.

The optical layer RCL may be directly located on the input sensor IS. The optical layer RCL may decrease reflectance for external light incident from the outside of the display device ED. In one or more embodiments, the optical layer RCL may include a polarizing layer or a color filter layer. In one or more embodiments of the present disclosure, each location of the input sensor IS and the optical layer RCL may be changed. For example, the optical layer RCL may include a polarizing layer, and the polarizing layer may be bonded to the input sensor IS via the adhesion layer.

The polarizing layer may be manufactured by adsorbing dichroic dyes onto a stretched polymer film. For example, the polarizing layer may be manufactured by adsorbing iodine onto a stretched polyvinyl alcohol film. In this case, a stretched direction of the polymer film may be an absorption axis of the polarizing layer, and a perpendicular direction to the stretched direction may be a transmission axis of the polarizing layer.

The color filter layer may include a plurality of color filters. The color filters may have an arrangement (e.g., predetermined arrangement). For example, the color filters may be arranged in consideration of emission colors of pixels included in the display panel DP. In addition, an anti-reflection layer ARL may further include a black matrix adjacent to the color filters.

FIG. 6A to FIG. 6C are views each schematically illustrating a cross-section of one configuration included in the display device ED according to one or more embodiments. FIG. 6A to FIG. 6C each briefly illustrates only a configuration of the optical layer RCL, the window adhesion layer AP-W, and the window WM among configurations included in the display device ED described in FIG. 3 and FIG. 4.

Windows WM, WM-1, and WM-2 according to one or more embodiments, which will be explained with reference to FIG. 6A to FIG. 6C may be included as the window WM of the display device ED according to one or more embodiments explained with reference to FIG. 1A to FIG. 4. The windows WM, WM-1, and WM-2 according to one or more embodiments, which will be explained with reference to FIG. 6A to FIG. 6C may be used as a cover window of the display device ED. In one or more embodiments, the windows WM, WM-1, and WM-2 according to one or more embodiments, which will be explained with reference to FIG. 6A to FIG. 6C may include at least one folding part FP-W (see FIG. 3) being folded with respect to the folding axis FX1 (see FIG. 3) extending to one direction.

Referring to FIG. 6A, the window WM according to one or more embodiments of the present disclosure includes a cover layer CVL. The cover layer CVL may be located on the display module DM (see FIG. 3). The cover layer CVL may protect the display module DM (see FIG. 3) from the external impact. The window WM according to one or more embodiments may further include a protecting layer PL located on the cover layer CVL. In addition, the window WM according to one or more embodiments may further include a protective adhesion layer AP-PL located between the cover layer CVL and the protecting layer PL.

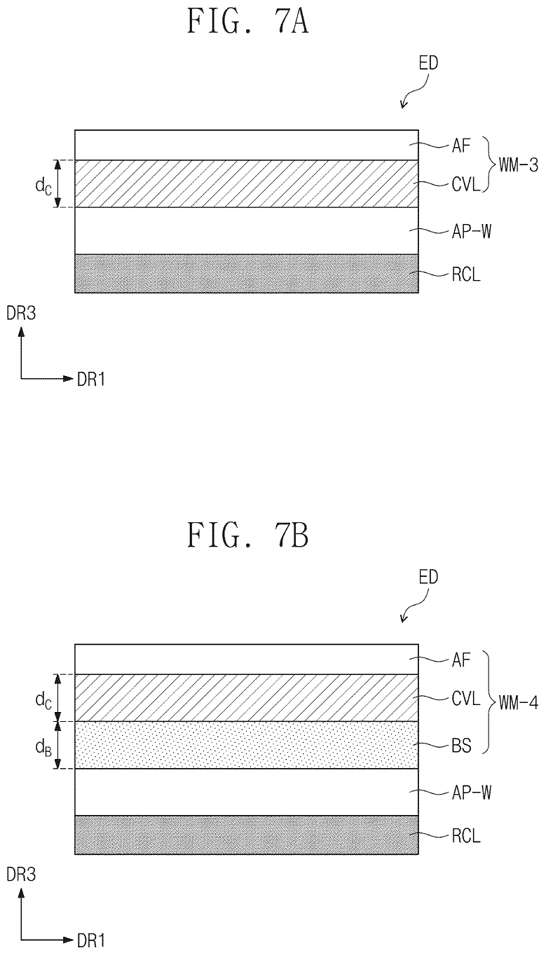

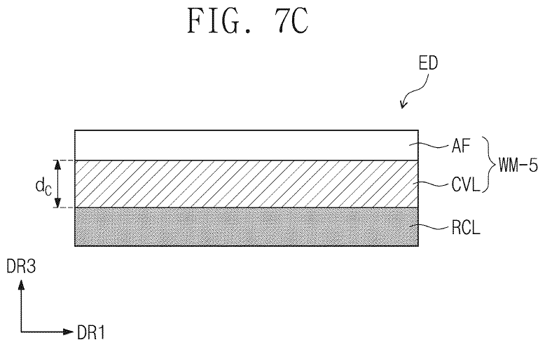

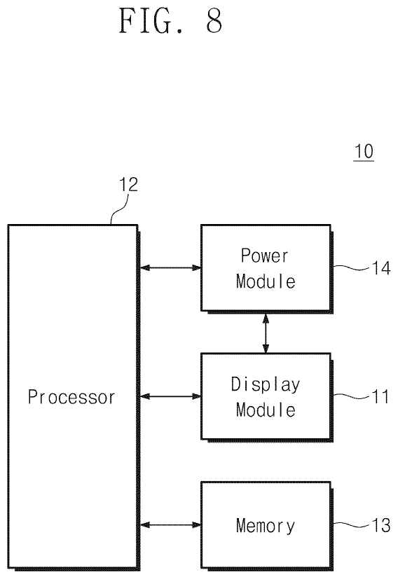

Hereinafter, the content explaining for the cover layer CVL included in the window WM may be similarly applied to, in addition to the window WM according to one or more embodiments illustrated in FIG. 6A, configurations of windows WM-1, WM-2, WM-3, WM-4, and WM-5 according to one or more embodiments, described with reference to FIG. 6B, FIG. 6C, FIG. 7A to FIG. 7C, etc.

The cover layer CVL includes: a base resin including at least one among a siloxane-epoxy-based compound, an epoxy (meth)acrylate-based compound, and/or a urethane (meth)acrylate-based compound; a siloxane functionalized polyol; a diglycidyl ether compound; a photo initiator; and a sensitizer. The cover layer CVL includes: a base resin including at least one among a siloxane-epoxy-based compound, an epoxy (meth)acrylate-based compound, and/or a urethane (meth)acrylate-based compound; a siloxane functionalized polyol; a diglycidyl ether compound; a photo initiator; and a sensitizer, and thus high hardness properties and excellent flexibility may be exhibited. Therefore, the cover layer CVL may improve impact resistance and folding properties of the window WM according to one or more embodiments.

The base resin may serve as a main binder forming a cover layer CVL. The base resin included in the cover layer CVL includes at least one among a siloxane-epoxy-based compound, an epoxy (meth)acrylate-based compound, and/or a urethane (meth)acrylate-based compound. The cover layer CVL may include, as a base resin, only one among the siloxane-epoxy-based compound, the epoxy (meth)acrylate-based compound, and the urethane (meth)acrylate-based compound, or may include two or more thereof. In the present specification, (meth)acrylate may mean acrylate and methacrylate.

The siloxane-epoxy-based compound shows high hardness and flexibility. The epoxy (meth)acrylate-based compound has excellent hardness, flexibility, and curing property derived from an epoxy resin. Because the urethane (meth)acrylate-based compound has excellent curing property, strong coating film may be obtained, thereby exhibiting excellent curing property even in an environment of high oxygen concentration. In a foldable display device, the cover layer CVL included in the window should be formed using a material that has high hardness, and should exhibit a certain degree of flexibility during a bending or folding operation. The cover layer CVL according to one or more embodiments of the present disclosure includes a base resin including at least one among the siloxane-epoxy-based compound, the epoxy (meth)acrylate-based compound, and/or the urethane (meth)acrylate-based compound, and thus excellent impact resistance and high flexibility may be secured.

In one or more embodiments, the base resin included in the cover layer CVL may be the siloxane-epoxy-based compound. When the base resin includes the siloxane-epoxy-based compound, the cover layer CVL derived therefrom may have improved properties of hardness and flexibility.

In one or more embodiments of the present disclosure, the siloxane-epoxy-based compound may be formed by including an alkoxysilane fused compound having an epoxy group. For example, the alkoxysilane fused compound having an epoxy group may be a siloxane resin including an epoxy group. However, one or more embodiments of the present disclosure is not limited thereto. In the present specification, the epoxy group included in the siloxane-epoxy-based compound may be one or more epoxy group selected from an aliphatic epoxy group and an aromatic epoxy group, or a functional group including the same. In addition, the siloxane resin may refer to a polymer compound in which a silicon atom and oxygen form a covalent bond.

In one or more embodiments, the base resin may be included in an amount of about 70 wt % to about 80 wt % with respect to the total content of the cover layer CVL. When the base resin is contained in an amount of about 70 wt % to about 80 wt % with respect to the total content of the cover layer CVL, the cover layer CVL may exhibit both high hardness property and excellent folding property.

In one or more embodiments, a siloxane functionalized polyol included in the cover layer CVL may be used as a crosslinking agent. The siloxane functionalized polyol according to one or more embodiments may have the similar structure and properties with the base resin, and thus, crosslinking of the base resin may be accelerated. Because the siloxane functionalized polyol improves crosslinking degree of the base resin, mechanical strength of the cover layer CVL may be increased, and flexibility may be added. The cover layer CVL includes the siloxane functionalized polyol, which may exhibit properties of high strength and excellent flexibility. Accordingly, the window WM including the cover layer CVL may have improvements in both impact resistance and folding properties.

In the present specification, the siloxane functionalized polyol may refer to a compound formed by performing an addition reaction of an organic silicon compound including a functional group including a silicon and oxygen bond (Si—O) with a polyol. In addition, in the present specification, the polyol may refer to an organic compound including a plurality of hydroxy groups within a molecule. For example, the polyol may refer to an organic compound including three or more hydroxy groups within a molecule.

Examples of polyol, which is not particularly limited, may include a polycaprolactone polyol, a polycarbonate polyol, a polyester polyol, a polyether polyol, a polythioether polyol, etc. In one or more embodiments, the siloxane functionalized polyol may include polycaprolactone polyol. That is, the siloxane functionalized polyol may be a siloxane functionalized polycaprolactone polyol.

In one or more embodiments, the siloxane functionalized polyol may be included in an amount of about 5 wt % to about 10 wt % with respect to the total amount of the cover layer CVL. When the siloxane functionalized polyol is included in an amount of about 5 wt % to about 10 wt % with respect to the total amount, curing property may be improved to thus obtain a thin film having excellent mechanical properties.

The cover layer CVL according to one or more embodiments may include an epoxy group-containing monomer as a photopolymerizable monomer. The cover layer CVL may include a diglycidyl ether compound as the photopolymerizable monomer. The diglycidyl ether compound contains two epoxy groups, and thus may cause sufficient polymerization when exposed to light during a curing process, and thus a film having excellent impact resistance and flexibility may be provided.

Examples of the diglycidyl ether compound may include bisphenol A diglycidyl ether, bisphenol F diglycidyl ether, resorcinol diglycidyl ether, bisphenol A propoxylate diglycidyl ether, ethylene glycol diglycidyl ether, 1,4-cyclohexanedimethanol diglycidyl ether, glycerol diglycidyl ether, 1,4-butanediol diglycidyl ether, neopentyl diglycidyl ether, 1,3-butanediol diglycidyl ether, 1,3-bis(3-glycidoxypropyl)tetramethylsiloxane, or a combination thereof, but is not limited thereto. In one or more embodiments, the diglycidyl ether compound may be bisphenol A diglycidyl ether.

1 In one or more embodiments, the diglycidyl ether compound may be included in an amount of about 1 wt % to about 5 wt % with respect to the total amount of the cover layer CVL. When the diglycidyl ether compound is included in an amount of about 1 wt % to about 5 wt % with respect to the total content of the cover layer CVL, curing reactivity is improved, and thus a thin film having an excellent mechanical property may be obtained. When the content of the diglycidyl ether compound less than about 1 wt %, curing efficiency may decrease, and when the content of the diglycidyl ether compound exceeds about 5 wt %, strength property of the cover layer CVL formed after curing may deteriorate.

The photo initiator included in the cover layer CVL according to one or more embodiments may include at least one among iodonium salt, sulfonium salt, tropylium salt, an acetophenone-based compound, a sulfonium-based compound, a benzophenone-based compound, and/or an organic halide.

In a case of the siloxane-based resin, a cationic initiator may be used as a material generating radicals or ions upon UV irradiation. That is, the cationic initiator which generates cations upon UV irradiation may be used. Types of the cationic initiators may include, for example, without particular limitation, triphenyl methyl chloride, tropylium halide, iodobenzene, etc. For the acrylate-based resin, an acetophenone-based initiator, a sulfonium salt-based initiator, and a benzophenone-based initiator may be used. However, types of initiators are not limited thereto.

The iodonium salt initiator may include diphenyl iodonium, di-p-tolyliodonium, bis(4-dodecylphenyl)iodonium, bis(4-methoxyphenyl)iodonium, (4-octyloxyphenyl)phenyliodonium, bis(4-decyloxy)phenyliodonium, 4-(2-hydroxytetradecyloxy)phenylphenyliodonium, 4-isopropylphenyl(p-tolyl)iodonium, 4-isobutylphenyl(p-tolyl)iodonium, or a combination thereof, but is not limited thereto.

The acetophenone-based initiator may include, for example, benzyl dimethyl ketal, 1-hydroxycyclohexyl phenyl ketone, bis(2,4,6-trimethylbenzoyl)phenylphosphine oxide, 4-phenoxy dichloroacetophenone, 4-t-butyl dichloroacetophenone, 4-t-butyl trichloroacetophenone, 2,2-diethoxyacetophenone, 2-hydroxy-2-methyl-1-phenyl-propan-1-one, 1-(4-isopropylphenyl)-2-hydroxy-2-methyl-propan-1-one, or a combination thereof, but is not limited thereto.

The benzophenone-based initiator may include, for example, benzophenone, 4-phenyl benzophenone, hydroxy benzophenone, acrylated benzophenone, 4,4′-bis(dimethylamino)benzophenone, 4,4′-dichlorobenzophenone, 3,3′-dimethyl-2-methoxybenzophenone, or a combination thereof, but is not limited thereto.

In one or more embodiments, the photo initiator may be included in an amount of about 3 wt % to about 5 wt % with respect to the total amount of the cover layer CVL. When the photo initiator is included in an amount of about 3 wt % to about 5 wt % with respect to the total amount of the cover layer CVL, curing efficiency may be improved, and thus a decrease in physical properties of the cover layer CVL after curing may be reduced or minimized.

The cover layer CVL according to one or more embodiments includes a sensitizer. The sensitizer included in the cover layer CVL may be a different compound from the initiator. The sensitizer may improve reactivity of polymerization to thereby improve mechanical strength of the cover layer CVL. The sensitizer may be, for example, a thioxanthone-based compound, a carbonyl-based compound, a diazo-based compound, etc.

In one or more embodiments, the sensitizer may be a thioxanthone-based compound. The thioxanthone-based compound may be, for example, isopropyl thioxanthone, 2-chlorothioxanthone, 2-methylthioxanthone, 2,4-diethylthioxanthone, 2,4-diisopropylthioxanthone, or a combination thereof, but is not limited thereto.

In one or more embodiments, the sensitizer may be included in an amount of about 1 wt % to about 5 wt % with respect to the total amount of the cover layer CVL. When the sensitizer is included in an amount of about 1 wt % to about 5 wt % with respect to the total amount of the cover layer CVL, curing efficiency may be improved, and thus, a decrease in physical properties of the cover layer CVL after curing may be reduced or minimized.

In the window WM according to one or more embodiments, the cover layer CVL may include about 70 wt % to about 80 wt % of the base resin, about 5 wt % to about 10 wt % of the siloxane functionalized polyol, about 1 wt % to about 5 wt % of the diglycidyl ether compound, about 3 wt % to about 5 wt % of the photo initiator, and about 1 wt % to about 5 wt % of the sensitizer. The amounts of the base resin, the siloxane functionalized polyol, the diglycidyl ether compound, the photo initiator, and the sensitizer, respectively fall within the above-described ranges, curing reactivity of the cover layer CVL may be improved, and impact resistance and flexibility may be improved.

In one or more embodiments, the cover layer CVL may have a modulus of about 500 Mpa or more and about 1.5 Gpa or less at a room temperature (e.g., about 25° C.). In one or more embodiments, when the cover layer CVL has a modulus of less than about 500 Mpa at a room temperature (e.g., about 25° C.), hardness is decreased, and thus impact resistance may deteriorate. In addition, in one or more embodiments, when the modulus of the cover layer CVL is greater than about 1.5 Gpa at a room temperature (e.g., about 25° C.), bending or folding stress may not be absorbed, which causes crack in the cover layer CVL. When the modulus of the cover layer CVL falls within the above-described range, the cover layer CVL has an advantage of high flexibility, and durability of the display device ED may be improved or maximized during physical operation, such as folding or bending.

In one or more embodiments, the cover layer CVL may have a thickness (dc) of about 30 μm to about 75 μm. When the thickness (dc) of the cover layer CVL is less than about 30 μm, sufficient impact resistant properties may not be exhibited, and when the thickness (dc) of the cover layer CVL is greater than about 75 μm, folding or bending properties of the display device ED may deteriorate. When the thickness (dc) of the cover layer CVL falls within the above-described range, the cover layer CVL may maintain flexibility while having excellent hardness, and thus may exhibit improved mechanical properties.

The window of the display device should have appropriate flexibility in folding operation while exhibiting excellent mechanical properties for protecting the display device from external stimulus. For example, because the window located on the top of the display device may come into artificially contact with the outside, high resistance to external impact and the like may be suitable. However, it may be conventionally difficult for the window of the display device to have both the suitable impact resistance and flexibility.

The window according to one or more embodiments of the present disclosure includes a cover layer including: a base resin including at least one among a siloxane-epoxy-based compound, an epoxy (meth)acrylate-based compound, and/or a urethane (meth)acrylate-based compound; a siloxane functionalized polyol; a diglycidyl ether compound; a photo initiator; and a sensitizer, and thus excellent impact resistance and excellent folding properties may be exhibited at the same time. Therefore, the window according to one or more embodiments may be used as a cover window of a foldable display device.

The display device according to one or more embodiments of the present disclosure includes a folding region and a non-folding region, and includes a window located on a display module and including: a base resin including at least one among a siloxane-epoxy-based compound, an epoxy (meth)acrylate-based compound, and/or a urethane (meth)acrylate-based compound; a siloxane functionalized polyol; a diglycidyl ether compound; a photo initiator; and a sensitizer, and thus excellent impact resistance and excellent folding properties may be exhibited.

Referring to FIG. 6A again, the window WM according to one or more embodiments may further include a protecting layer PL located on the cover layer CVL. The protecting layer PL may be located on the cover layer CVL. The protecting layer PL may be spaced apart from the display module DM (see FIG. 3) with the cover layer CVL therebetween. The protecting layer PL may be located on the cover layer CVL to protect the window WM from an external environment. However, in the display device ED according to one or more embodiments, the protecting layer PL and the protective adhesion layer AP-PL may be omitted, and the cover layer CVL may be an uppermost surface of the display device ED.

The protective adhesion layer AP-PL may be further located between the cover layer CVL and the protecting layer PL. The protective adhesion layer AP-PL may be an optically clear adhesive layer. When the display device ED according to one or more embodiments includes the protecting layer PL, the protecting layer PL may be a layer exposed to the outside in the display device ED.

The protecting layer PL may include a polymer film. In addition, the protecting layer PL may include a polymer film as a base layer, and may further include a functional layer, such as a hard coating layer, an anti-fingerprint coating layer, and an anti-static coating layer, on the base layer. The protecting layer PL used in the display device ED according to one or more embodiments may have flexibility.

In one or more embodiments, the protecting layer PL may be located on the cover layer CVL. The protecting layer PL may be a functional layer protecting the top surface of the cover layer CVL.

The protecting layer PL according to one or more embodiments may include at least one polymer resin among polyethylene terephthalate (PET), poly(butylene terephthalate) (PBT), polyethylene naphthalene (PEN), polycarbonate (PC), poly (methyl methacrylate) (PMMA), polystyrene (PS), polyvinylchloride (PVC), polyether sulfone (PES), polypropylene (PP), polyamide (PA), modified polyphenylene ether (m-PPO), polyoxymethylene (POM), polysulfone (PSU), polyphenylene sulfide (PPS), polyimide (PI), polyethyleneimine (PEI), polyether ether ketone (PEEK), polyamide imide (PAI), polyarylate (PAR), and/or thermoplastic polyurethane (TPU). The protecting layer PL may be a polymer film layer, and, for example, in one or more embodiments, the protecting layer PL may be a polyethylene terephthalate (PET) film, or a thermoplastic polyurethane (TPU) film.

In the display device ED according to one or more embodiments, the window WM may be located on the display module DM (see FIG. 3). The window WM may be located on the optical layer RCL included in the display module DM (see FIG. 3). The window WM may adhere to the display module DM (see FIG. 3) through a window adhesion layer AP-W. In one or more embodiments, the cover layer CVL may be located on the optical layer RCL. As illustrated in FIG. 6A, the cover layer CVL may adhere to the optical layer through the window adhesion layer AP-W. However, one or more embodiments of the present disclosure is not limited thereto, and, in the display device ED according to one or more embodiments, the window adhesion layer AP-W may be omitted, and the cover layer CVL may be directly located on the optical layer RCL.

Referring to FIG. 6A. a window WM-1 according to one or more embodiments may further include a base layer BS located under a cover layer CVL. The base layer BS may be located between the cover layer CVL and the optical layer RCL. The cover layer CVL may be located to be spaced apart from a display module DM (see FIG. 3) with the base layer BS therebetween. The cover layer CVL may be directly located on the base layer BS.

The base layer BS may be formed using a polymer material. The base layer BS may be a polymer film having flexibility. In one or more embodiments, the base layer BS may have high transparency, high mechanical strength, high thermal stability, excellent moisture-blocking property, and isotropic optical property.

The base layer BS may be manufactured using a polyamide-based resin; a polyaramid-based resin; a polyester-based resin, such as polyethylene terephthalate, polyethylene iso phthalate, or polybutylene terephthalate; a cellulose-based resin, such as diacetyl cellulose, or a triacetyl cellulose; a polycarbonate-based resin; an acryl-based resin, such as polymethyl (meth)acrylate, or polyethyl (meth)acrylate; a styrene-based resin, such as a polystyrene acrylonitrile-styrene copolymer; a polyolefin-based resin, such as polyethylene, polypropylene, a polyolefin-based resin having a cyclo- or novonene-based structure, an ethylene propylene copolymer, etc.; a polyether sulfone-based resin, or a sulfone-based resin; etc. In addition, the base layer BS may be formed using one alone among the resins, or using a mixture of two or more of the resins. However, types of resins forming the base layer BS is not limited thereto. In the window WM-1 according to one or more embodiments, the base layer BS may be a polyethylene terephthalate film.

The base layer BS may have a thickness (dB) of about 20 μm to about 50 μm. When the thickness (dB) of the base layer BS is less than about 20 μm, durability of the window WM may decrease. In addition, when the thickness (dB) of the base layer BS is greater than about 50 μm, the window WM becomes thick, which may be unsuitable for implementing a thin display device or foldable display device.

The base layer BS may be a single polymer film layer. However, one or more embodiments of the present disclosure is not limited thereto, and the base layer BS may be provided as a form in which a plurality of polymer films is stacked.

In the display device ED according to one or more embodiments, the window WM-1 may be located on the display module DM (see FIG. 3). The window WM-1 may be located on the optical layer RCL included in the display module DM (see FIG. 3). The window WM-1 may adhere to the display module DM (see FIG. 3) through the window adhesion layer AP-W. The window WM-1 according to one or more embodiments may include the base layer BS, the cover layer CVL, the protective adhesion layer AP-PL, and the protecting layer PL, which are sequentially stacked along the third direction DR3. In one or more embodiments, the base layer BS may be directly located on the window adhesion layer AP-W, and the cover layer CVL may be directly located on the base layer BS.

The display device ED according to one or more embodiments, illustrated in FIG. 6C differs from the display device ED according to one or more embodiments, illustrated in FIG. 6A in that the window adhesion layer AP-W is omitted.

Referring to FIG. 6C, a window WM-2 includes the cover layer CVL, the protective adhesion layer AP-PL. and the protecting layer PL, which are sequentially stacked along the third direction DR3 that is a thickness direction. The window WM-2 according to one or more embodiments may be directly located on the display module DM (see FIG. 3). As illustrated in FIG. 6C, the cover layer may be directly located on the display module DM (see FIG. 3). The cover layer CVL may be directly located on the optical layer RCL. The bottom surface of the cover layer CVL may be in contact with the optical layer RCL.

In one or more embodiments, the window WM-2 according to one or more embodiments, illustrated in FIG. 6C, may further include the base layer BS (see FIG. 6B) located below the cover layer CVL. In this case, in the window WM-2 according to one or more embodiments, the base layer BS (FIG. 6B) may be directly located on the optical layer RCL.

In addition, the descriptions for the components included in the above-described window WM in FIG. 6A may be similarly applied to each component included in the windows WM-1 and WM-2 according to one or more embodiments, respectively illustrated in FIG. 6B and FIG. 6C. That is, the contents for the cover layer CVL, the protective adhesion layer AP-PL, and the protecting layer PL, described with reference to FIG. 6A, may be similarly applied to the cover layer CVL, the protective adhesion layer AP-PL, and the protecting layer PL in the windows WM-1 and WM-2 according to one or more embodiments.

Each of FIG. 7A to FIG. 7C is a view schematically illustrating a cross-section of a configuration included in the display device ED according to one or more embodiments. Configurations only of the optical layer RCL, the window adhesion layer AP-W, and the window WM among the configurations included in the display device ED, described previously in FIG. 3 and FIG. 4, are briefly illustrated in FIG. 7A to FIG. 7C. Hereinafter, in descriptions of windows WM-3, WM-4, and WM-5, each according to one or more embodiments of the present disclosure with reference to FIG. 7A to FIG. 7C, the same contents as the descriptions explained with reference to FIG. 6A to FIG. 6C are omitted, and differences will be described in detail.

The windows WM-3, WM-4, and WM-5, each according to one or more embodiments, which will be described with reference to FIG. 7A to FIG. 7C, may be included as a window of the display device ED. The windows WM-3, WM-4, and WM-5, each according to one or more embodiments, which will be described with reference to FIG. 7A to FIG. 7C, may be include as a cover window of the display device ED. In one or more embodiments, the windows WM-3, WM-4, and WM-5, each according to one or more embodiments, which will be described with reference to FIG. 7A to FIG. 7C, may include at least one folding part FP-W (see FIG. 3) folded with respect to a folding axis FX1 (see FIG. 3) that extends to one direction.

In the windows WM-3, WM-4, and WM-5, each according to one or more embodiments, respectively illustrated in FIG. 7A to FIG. 7C, the protecting layer PL and the protective adhesion layer AP-PL may be omitted, which differs from the windows WM, WM-1, and WM-2 respectively illustrated in FIG. 6A to FIG. 6C. The descriptions for components included in the above-described windows WM, WM-1, and WM-2 respectively illustrated in FIG. 6A to FIG. 6C may be similarly applied to components included in the windows WM-3, WM-4, and WM-5, according to embodiments, respectively illustrated in FIG. 7A to FIG. 7C.

Referring to FIG. 7A, the window WM-3 according to one or more embodiments may include a cover layer CVL, and a functional layer AF located on the cover layer CVL. The functional layer AF may be spaced apart from the display module DM (see FIG. 3) with the cover layer CVL therebetween. The functional layer AF may be directly located on the cover layer CVL. In addition, the functional layer AF may be located on the cover layer CVL through the adhesion layer, in one or more embodiments. In the window WM-3 according to one or more embodiments, the functional layer AF may be located on the outermost edge of the window WM-3.

The functional layer AF may be formed including a single layer or a plurality of layers. The functional layer AF may include at least one among a hard coating layer, an anti-fingerprint layer, and/or an anti-dust layer. In one or more embodiments, the functional layer AF may include at least one among a hard coating material, and/or an anti-fingerprint layer.

When the functional layer AF includes a hard coating layer, the hard coating layer may serve to protect the window WM-3 or the display module DM (see FIG. 3). The hard coating layer may include a hard coating material. The hard coating layer may be formed from a resin for the hard coating layer including at least one among an organic composition, an inorganic composition, and/or an organic-inorganic composite composition. For example, the hard coating material forming the hard coating layer may include at least one among an acrylate-based compound, a siloxane compound, or a silsesquioxane compound. In addition, the hard coating material may further include an inorganic particle. The hard coating layer may be an organic layer, an inorganic layer, or an organic-inorganic composite material layer.

When the functional layer AF includes an anti-fingerprint layer, the anti-fingerprint layer may serve to improve stain resistance of the window WM-3. The anti-fingerprint layer may include an anti-fingerprint material. The anti-fingerprint material may include a water-repellent material or an oil-repellent material. For example, the anti-fingerprint material may include a fluorine-containing compound. The fluorine-containing compound may include at least one among polytetra fluoroethylene (PTFE), polyvinylidene fluoride (PVDF), and/or amorphous fluoropolymer (Teflon AF, and Cytop® (Cytop® being a registered trademark of CYTEC TECHNOLOGY CORP. (CORPORATION; DELAWARE, USA).

The thickness of the functional layer AF may be about 10 μm or less. For example, the thickness of the functional layer AF may be about 1 μm to about 10 μm. If the thickness of the functional layer AF is less than about 1 μm, functions for protecting the window WM-3 or the display module DM (see FIG. 3) deteriorate, and thus the display device ED (see FIG. 3) may have reduced durability. In addition, if the thickness of the functional layer AF exceeds about 10 μm, a thickness of the window WM-3 thickens, which may be unsuitable for implementing of a thin display device or a foldable display device. When the thickness of the functional layer AF falls within the above-described range, the functional layer AF may exhibit excellent durability. Therefore, the window WM-3 including the functional layer AF maintains flexibility while having excellent hardness, and thus intrinsic mechanical property may be exhibited.

In the display device ED according to one or more embodiments, the window WM-3 may be located on the display module DM (see FIG. 3). The window WM-3 may be located on the optical layer RCL included in the display module DM (see FIG. 3). The window WM may adhere to the display module DM (see FIG. 3) through the window adhesion layer AP-W. In one or more embodiments, the cover layer CVL may be located on the optical layer RCL. As illustrated in FIG. 7A, the cover layer CVL may adhere to the optical layer RCL through the window adhesion layer AP-W. However, one or more embodiments of the present disclosure is not limited thereto, and in the display device ED according to one or more embodiments, the window adhesion layer AP-W may be omitted, and the cover layer CVL may be directly located on the cover layer RCL.

Referring to FIG. 7B, a window WM-4 according to one or more embodiments, illustrated in FIG. 7B may further include the base layer BS, which differs from the window WM-3 according to one or more embodiments, illustrated in FIG. 7A. The base layer BS may be located below the cover layer CVL. The base layer BS may be located between the cover layer CVL and the optical layer RCL. The cover layer CVL may be located to be spaced apart from the display module DM (see FIG. 3) with the base layer BS therebetween.

In the display device ED according to one or more embodiments illustrated in FIG. 7C, the window adhesion layer AP-W is omitted, which differs from the display device ED according to one or more embodiments illustrated in FIG. 7A.

Referring to FIG. 7C, a window WM-5 according to one or more embodiments may be directly located on the display module DM (see FIG. 3). As illustrated in FIG. 7C, the cover layer CVL may be directly located on the display module DM (see FIG. 3). The cover layer CVL may be directly located on the optical layer RCL. The bottom surface of the cover layer CVL may be in contact with the optical layer RCL.

In one or more embodiments, the window WM-5 according to one or more embodiments, illustrated in FIG. 6C, may further include the base layer BS (see FIG. 7B) located below the cover layer CVL. In this case, in the window WM-5 according to one or more embodiments, the base layer BS (FIG. 7B) may be directly located on the optical layer RCL.

A display device according to an embodiment may be applied to various electronic devices. An electronic device according to an embodiment may include the foregoing display device, and further include a module or device having other additional function in addition to the display device.

FIG. 8 is a block diagram of an electronic device according to an embodiment. Referring to FIG. 8, an electronic device 10 according to an embodiment may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), or a controller.

The memory 13 may store data information required for an operation of the processor 12 or the display module 11. When the processor 12 executes an application stored in the memory 13, an image data signal and/or an input control signal may be transmitted to the display module 11, and the display module 11 may process the provided signal and output image information through a display screen.

The power module 14 may include a power supply module such as a power adapter or a battery device, and a power conversion module which converts power supplied by the power supply module and generates power required for an operation of the electronic device 10.

At least one of the components of the electronic device 10 described above may be included in the display device according to an embodiment described above. In addition, some of individual modules included as functional in one module may be included in the display device, and others may be provided separately from the display device. For example, the display device may include the display module 11, and the processor 12, the memory 13, and the power module 14 may be provided not in the display device but in another type of device in the electronic device 10.

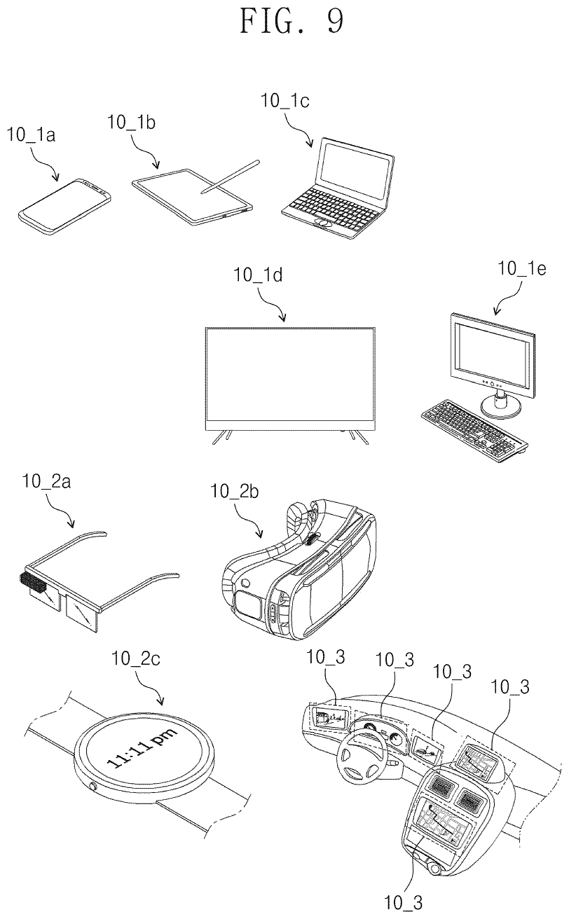

FIG. 9 illustrates schematic views of electronic devices according to various embodiments.

Referring to FIG. 9, various electronic devices to which the display device according to an embodiment is applied may include not only electronic devices for displaying images, e.g., a smartphone 10_1a, a tablet computer (PC) 10_1b, a laptop computer 10_1c, TV 10_1d, and a monitor for a desk computer 10_1e, but also wearable electronic devices including display modules, e.g., smart glasses 10_2a, a head mounted display 10_2b, and a smart watch 10_2c, and vehicle electronic devices 10_3 including display modules, e.g., a vehicle instrument panel, a center fascia, a center information display (CID) disposed on a dashboard, and a room mirror display.

Hereinafter, with reference to Examples and Comparative Examples, the window according to one or more embodiments and a display device including the same will be described. However, Examples shown below are only for helping the understanding of the present disclosure, and the present disclosure is not limited to Examples and Comparative Examples below.

### Evaluation 1 of Display Device

A thickness of each component included in the window included in the display devices according to Example 1-1 to Example 1-3, Example 2-1 to Example 2-3, Comparative Example 1, Comparative Example 1-1, Comparative Example 1-2, Comparative Example 2-1, and Comparative Example 2-2 is shown in Table 1 below. In Table 1 below, a thickness of “0” for a listed component indicates that no corresponding component is included. In Table 1, the display device according to Comparative Example 1 includes a stacking structure of a window and a display module, including a glass substrate (ultra-thin glass, UTG) and the display devices according to Example 1-1 to Example 1-3, Example 2-1 to Example 2-3, Comparative Example 1-1, Comparative Example 1-2, Comparative Example 2-1, and Comparative Example 2-2 1 each include a stacking structure of a window and the display module, including a cover layer. The windows respectively included in the display devices according to Example 1-1 to Example 1-3, Example 2-1 to Example 2-3, Comparative Example 1-1, Comparative Example 1-2, Comparative Example 2-1, and Comparative Example 2-2 may have the window structure in FIG. 6B.

Polyethylene terephthalate (PET) was used as a base layer in the display devices according to Example 1-1 to Example 1-3, Example 2-1 to Example 2-3, Comparative Example 1-1, Comparative Example 1-2, Comparative Example 2-1, and Comparative Example 2-2. In addition, in the windows according to Example 1-1 to Example 1-3, Example 2-1 to Example 2-3, Comparative Example 1-1, Comparative Example 1-2, Comparative Example 2-1, and Comparative Example 2-2, a cover layer includes a siloxane-epoxy-based resin, a siloxane functionalized polyol, a diglycidyl ether compound, a photo initiator, and a sensitizer. A siloxane functionalized caprolactone polyol was used as the siloxane functionalized polyol, bisphenol A diglycidyl ether was used as the diglycidyl ether compound, diphenyliodonium chloride was used as a photo initiator, and isopropylthioxanthone was used as the sensitizer. In the display devices according to Example 1-1 to Example 1-3, Example 2-1 to Example 2-3, Comparative Example 1-1, Comparative Example 1-2, Comparative Example 2-1, and Comparative Example 2-2, a thickness and a material composition of each of the other stacked components are the same.

TABLE 1

| | | | Protective | | |
|---|---|---|---|---|---|
| | Base | Cover | adhesion | Protecting | Glass |
| | layer | layer | layer | layer | substrate |
| Classification | (μm) | (μm) | (μm) | (μm) | (μm) |
| Example 1-1 | 23 | 30 | 35 | 80 | 0 |
| Example 1-2 | 23 | 50 | 35 | 80 | 0 |
| Example 1-3 | 23 | 75 | 35 | 80 | 0 |
| Example 2-1 | 50 | 30 | 35 | 80 | 0 |
| Example 2-2 | 50 | 50 | 35 | 80 | 0 |
| Example 2-3 | 50 | 75 | 35 | 80 | 0 |
| Comparative | 0 | 0 | 35 | 80 | 30 |
| Example 1 | | | | | |
| Comparative | 23 | 25 | 35 | 80 | 0 |
| Example 1-1 | | | | | |
| Comparative | 23 | 80 | 35 | 80 | 0 |
| Example 1-2 | | | | | |
| Comparative | 50 | 25 | 35 | 80 | 0 |
| Example 2-1 | | | | | |
| Comparative | 50 | 80 | 35 | 80 | 0 |
| Example 2-2 | | | | | |

Thicknesses of the display devices according to Example 1-1 to Example 1-3, are different from those of the display devices according to Example 2-1 to Example 2-3. In the display devices according to Example 1-1 to Example 1-3, the base layer has a thickness of about 23 μm, and, in the display devices according to Example 2-1 to Example 2-3, the base layer has a thickness of about 50 μm. The display device according to Example 1-1 includes a window in which a base layer of about 23 μm, a cover layer of about 50 μm, a protective adhesion layer of about 35 μm, and a protecting layer of about 80 μm are sequentially stacked. The display device according to Example 1-2 includes a window in which a base layer of about 23 μm, a cover layer of about 50 μm, a protective adhesion layer of about 35 μm, and a protecting layer of about 80 μm are sequentially stacked. The display device according to Example 1-3 includes a window in which a base layer of about 23 μm, a cover layer of about 75 μm, a protective adhesion layer of about 35 μm, and a protecting layer of about 80 μm are sequentially stacked.

The display device according to Example 2-1 includes a window in which a base layer of about 50 μm, a cover layer of about 30 μm, a protective adhesion layer of about 35 μm, and a protecting layer of about 80 μm are sequentially stacked. The display device according to Example 2-2 includes a window in which a base layer of about 50 μm, a cover layer of about 50 μm, a protective adhesion layer of about 35 μm, and a protecting layer of about 80 μm are sequentially stacked. The display device according to Example 2-3 includes a window in which a base layer of about 23 μm, a cover layer of about 75 μm, a protective adhesion layer of about 35 μm, and a protecting layer of about 80 μm are sequentially stacked.

In the display device according to Comparative Example 1, the base layer and the cover layer are omitted and replaced with a glass substrate UTG in the window structure in FIG. 6B. The display device according to Comparative Example 1 includes a window in which a glass substrate UTH of about 30 μm, a protective adhesion layer of about 35 μm, and a protecting layer of about 80 μm are sequentially stacked.

The window according to Comparative Example 1-1, as compared to the windows according to Example 1-1 to Example 1-3, corresponds to a window including a cover layer having a thickness of less than about 30 μm. That is, the display device according to Comparative Example 1-1 includes a window in which a base layer of about 23 μm, a cover layer of about 25 μm, a protective adhesion layer of about 35 μm, and a protecting layer of about 80 μm are sequentially stacked. The window according to Comparative Example 1-2, as compared to the windows according to Example 1-1 to Example 1-3, corresponds to a window including a cover layer having a thickness of greater than about 75 μm. That is, the display device according to Comparative Example 1-2 includes a window in which a base layer of about 23 μm, a cover layer of about 80 μm, a protective adhesion layer of about 35 μm, and a protecting layer of about 80 μm are sequentially stacked.

The window according to Comparative Example 2-1, as compared to the windows according to Example 2-1 to Example 2-3, corresponds to a window including a cover layer having a thickness of less than about 30 μm. That is, the display device according to Comparative Example 2-1 includes a window in which a base layer of about 50 μm, a cover layer of about 25 μm, a protective adhesion layer of about 35 μm, and a protecting layer of about 80 μm are sequentially stacked. The window according to Comparative Example 2-2, as compared to the windows according to Example 2-1 to Example 2-3, corresponds to a window including a cover layer of greater than about 75 μm. That is, the display device according to Comparative Example 2-2 includes a window in which a base layer of about 50 μm, a cover layer of about 80 μm, a protective adhesion layer of about 35 μm, and a protecting layer of about 80 μm are sequentially stacked.

As reliability tests for the display devices according to Example 1-1 to Example 1-3, Example 2-1 to Example 2-3, Comparative Example 1, Comparative Example 1-1, Comparative Example 1-2, Comparative Example 2-1, and Comparative Example 2-2, the ball drop test, the push force test, and evaluations of properties of a repulsive force and a torque during folding operation were carried out, and the results were listed in Table 2 below. For the ball drop test in Table 2, a height at which cracks first appeared in the window was measured when a weight was dropped from that height. In evaluation of properties by the push force pressure, the point at which cracks began to appear in the window was measured when the front of the display device was pressed with a pen at a constant speed. In evaluation of properties by the push force pressure, the tests were conducted on both the non-folding and folding parts of the display device, and each of the results is shown in Table 2.

TABLE 2

| | Ball drop(cm) | | | | |
|---|---|---|---|---|---|
| | Non- | | Push force | Repulsive | |
| | folding | Folding | pressure | force | Torque |
| Classification | part | part | (kgf) | (N) | (N · cm) |
| Example 1-1 | 10 | 8 | 1.3 | 2.18 | 14.82 |
| Example 1-2 | 11 | 9 | 1.4 | 2.16 | 14.67 |
| Example 1-3 | 11 | 9 | 1.8 | 2.27 | 15.44 |
| Example 2-1 | 8 | 7 | 1.5 | 2.57 | 17.48 |
| Example 2-2 | 9 | 8 | 1.9 | 2.77 | 18.84 |
| Example 2-3 | 11 | 10 | 2.3 | 3.01 | 20.47 |
| Comparative | 7 | 6 | 1.1 | 2.29 | 15.57 |
| Example 1 | | | | | |
| Comparative | 7 | 4 | 0.8 | 1.70 | 11.9 |
| Example 1-1 | | | | | |
| Comparative | 12 | 10 | 2.1 | 2.35 | 16.45 |
| Example 1-2 | | | | | |
| Comparative | 7 | 5 | 1.4 | 2.37 | 16.59 |
| Example 2-1 | | | | | |
| Comparative | 13 | 11 | 2.4 | 3.12 | 21.84 |
| Example 2-2 | | | | | |

Referring to the results in Table 2, the display devices according to Example 1-1 to Example 1-3, and Example 2-1 to Example 2-3 each have improved evaluation value on the ball drop and push force pressure tests, compared to the display device according to Comparative Example 1. Unlike the display devices according to Examples, the display device according to Comparative Example 1 including the glass substrate was damaged at a height of about 7 cm on the non-folding part of the window, and at a height of about 6 cm on the folding part of the window during the ball drop evaluation of impact resistance. Compared to this, the display devices according to Example 1-1 to Example 1-3, and Example 2-1 to Example 2-3 were damaged at a height of about 8 cm on the non-folding part of the window and at a height of about 7 cm on the folding part of the window during the ball drop evaluation of impact resistance. In addition, the display device according to Comparative Example 1 was broken at a height of about 1.1 cm on the window during the pushed force pressure evaluation. Compared to this, the display devices according to Example 1-1 to Example 1-3, and Example 2-1 to Example 2-3, were broken at a height of about 1.3 cm or more on the window during the pushed force pressure evaluation.

Through this, it can be confirmed that the display devices according to Example 1-1 to Example 1-3, and Example 2-1 to Example 2-3 exhibit a better performance than the display device according to Comparative Example 1 in the ball drop and push force tests. That is, it can be confirmed that the windows of Examples have improved impact resistance for external impact, as compared to the window of Comparative Example 1.

The display devices according to Example 1-1 to Example 1-3 differ from the display devices according to Example 2-1 to Example 2-3 in a thickness of the base layer. The display device of Comparative Example 1 including the glass substrate has a repulsive force of about 2.29. Compared to this, the display devices of Example 1-1 to Example 1-3 have a repulsive force of about 2.27 or less. Therefore, it can be confirmed that the display devices of Example 1-1 to Example 1-3 have a smaller repulsive force than the display device according to Comparative Example 1. The display devices according to Example 2-1 to Example 2-3 have a repulsive force value of about 2.57 or more, and thus it can be confirmed that the display devices of Example 2-1 to Example 2-3 have the higher repulsive force than those of Example 1-1 to Example 1-3, and Comparative Example 1. Accordingly, it can be confirmed that the repulsive force may be decreased by adjusting the thickness of the base layer included in the window to about 50 μm or less.

When comparing torque values of the display devices of Examples and Comparative Example 1 in Table 2, the display device of Comparative Example 1 including the glass substrate exhibited a torque value of about 15.57. Compared to this, the display devices of Example 1-1 to Example 1-3 exhibited torque values of about 15.44 or less. Therefore, it can be confirmed that the display devices of Example 1-1 to Example 1-3 have smaller torque values than the display device according to Comparative Example 1. It can be confirmed that the display devices of Example 2-1 to Example 2-3 have higher toque values than the display devices of Example 1-1 to Example 1-3, and Comparative Example 1. Accordingly, it can be confirmed that adjusting the thickness of the base layer to less than about 50 μm may result in a decrease in the torque value applied to the window. That is, when the thickness of the base layer is about 20 μm or more and less than about 50 μm, excellent folding reliability may be exhibited while exhibiting high impact resistance.

The display devices according to Example 1-1 to Example 1-3 may have excellent flexibility while maintaining high impact resistance at the same time. As compared to the display device according to Comparative Example, the display devices according to Example 1-1 to Example 1-3 may have excellent folding properties while having high impact resistance for the external impact. The base layers included in the display devices according to Example 2-1 to Example 2-3 have a greater thickness than the base layers included in the display devices according to Example 1-1 to Example 1-3. Compared to the display devices according to Example 1-1 to Example 1-3, it can be confirmed that the display devices according to Example 2-1 to Example 2-3, which have a thickness of the base layer of about 50 μm or greater, exhibit the similar values in the ball drop and push force pressure tests, but exhibit increases in a repulsive force and a torque value. Compared to this, it can be confirmed that the display devices according to Example 1-1 to Example 1-3 exhibit a low repulsive force and a low torque value while exhibiting an excellent performance in the ball drop and push force pressure tests. Therefore, it can be confirmed that when the thickness of the base layer falls within the thickness range of about 20 μm or greater, and less than about 50 μm, the window according to one or more embodiments has high impact resistance and good folding properties.

The windows of Comparative Example 1-1 and Comparative Example 1-2 differ from the windows of Example 1-1 to Example 1-3 in the thickness of the cover layer. The window of Comparative Example 1-1 corresponds to a window including a cover layer having a thickness of less than about 30 μm, as compared to the windows of Example 1-1 to Example 1-3. It can be confirmed that the display device according to Comparative Example 1-1 exhibits a lower repulsive force and a lower torque value than those of the display devices according to Example 1-1 to Example 1-3, but also exhibits a deteriorated performance in the ball drop and push force pressure tests. The window of Comparative Example 1-2 corresponds to the window including a cover layer having a thickness of greater than about 75 μm, as compared to the windows of Example 1-1 to Example 1-3. It can be confirmed that the display device according to Comparative Example 1-1 exhibits high values in the ball drop and push force pressure tests, but exhibits higher values in the repulsive force and torque value compared to the display device according to Example 1-1 to Example 1-3. Compared to this, it can be confirmed that the display devices according to Example 1-1 to Example 1-3 exhibit a lower repulsive force and a lower torque value while exhibiting an excellent performance in the ball drop and push force pressure tests. That is, it can be confirmed that when a thickness of the cover layer falls within a thickness range of about 30 μm to about 75 μm, the window according to one or more embodiments has high impact resistance and good folding property.

Similarly to this, as compared the display devices according to Comparative Example 2-1 and Comparative Example 2-2 with the display devices according to Example 2-1 to Example 2-3, it can be confirmed that the display device according to Comparative Example 2-1 having a thickness of the cover layer of less than about 30 μm exhibits a lower repulsive force and a lower torque value than those of the display devices according to Example 2-1 to Example 2-3, but exhibits a reduced performance on the ball drop and pushed force pressure tests. It can be confirmed that the display device according to Comparative Example 2-2 having a thickness of the cover layer of greater than about 75 μm exhibits a high value on the ball drop and pushed force pressure tests, but exhibits an increased repulsive force and a torque value than those of the display devices according to Example 2-1 to Example 2-3. Therefore, it can be confirmed that the impact resistance and folding reliability may be simultaneously improved by adjusting the thickness of the cover layer in about 30 μm to about 75 μm, included in the window.

### Evaluation 2 of Display Device

A thickness of each component included in the window included in the display devices according to Example 3-1 to Example 3-3, and Comparative Example 1 is shown in Table 3 below. In Table 3 below, a thickness of “0” for a listed component indicates that the corresponding component is not included. In Table 1, the display device according to Comparative Example 1 includes a stacking structure of the window and the display module which includes a glass substrate (UTG), and the display devices according to Example 3-1 to Example 3-3, each include a stacking structure of the window and the display module which includes a cover layer. In Table 3, the display device according to Comparative Example 1 may have the same structure as that of the display device according to Comparative Example 1, described in Table 1. In addition, in Example 3-1 to Example 3-3, a material composition of each component may be the same as those of Examples described in Table 1.

TABLE 3

| | Base | Cover | Protective | Protecting | Glass |
|---|---|---|---|---|---|
| | layer | layer | adhesion | layer | substrate |
| Classification | (μm) | (μm) | layer | (μm) | (μm) |
| Example 3-1 | 23 | 50 | 35 | 80 | 0 |
| Example 3-2 | 23 | 100 | 35 | 80 | 0 |
| Example 3-3 | 0 | 50 | 35 | 80 | 0 |
| Comparative | 0 | 0 | 35 | 80 | 30 |
| Example 1 | | | | | |

The display devices according to Example 3-1 to Example 3-3, and Comparative Example 1 were subjected to a measurement of uniformity index (Kc), and the results were listed in Table 4 below. The uniformity index (Kc) was measured using a uniformity index measurement system (Optima).

TABLE 4

| Classification | Uniformity index (Kc) |
|---|---|
| Example 3-1 | 0.35~0.40 |
| Example 3-2 | 0.33~0.35 |
| Example 3-3 | 0.38 |
| Comparative Example 1 | 0.40~0.44 |

Referring to results in Table 4, it can be confirmed that uniformity index of each display device according to Example 3-1 to Example 3-3 is lower than uniformity index of the display device according to Comparative Example 1. As the uniformity index is lower, a measured object may have a smoother surface. The display devices according to Example 3-1 to Example 3-3 may have higher uniformity index than the display device according to Comparative Example 1, and thus may have the smoother top surface. The display device according to Examples includes a window including the cover layer, and thus may exhibit a more improved uniformity index than the display device according to Comparative Example 1 including the glass substrate.

According to one or more embodiments of the present disclosure, the window includes a cover layer containing specific material, and thus impact resistance and folding properties thereof may be improved. Therefore, the display device including the window may have improved reliability and durability.

Hitherto, although the embodiments of the present disclosure have been described with reference to various embodiments, and those skilled in the art or having ordinary knowledge of the art will understand that various modifications and changes can be made without departing from the aspects of the present disclosure as described later in the claims, which will be described hereinafter. Accordingly, the technical scope of the present disclosure is not limited to what is set forth in the detailed description of the specification, but should be defined by the claims, with functional equivalents thereof to be included therein.

What is claimed is:

1. A window comprising a cover layer, the cover layer comprising:
a base resin comprising at least one of a siloxane-epoxy-based compound, an epoxy (meth)acrylate-based compound, or a urethane (meth)acrylate-based compound;
a siloxane functionalized polyol;
a diglycidyl ether compound;
a photo initiator; and
a sensitizer.

2. The window of claim 1, wherein the cover layer has a thickness of about 30 μm to about 75 μm.

3. The window of claim 1, wherein the cover layer comprises:
about 70 wt % to about 80 wt % of the base resin;
about 5 wt % to about 10 wt % of the siloxane functionalized polyol;
about 1 wt % to about 5 wt % of the diglycidyl ether compound;
about 3 wt % to about 5 wt % of the photo initiator; and
about 1 wt % to about 5 wt % of the sensitizer.

4. The window of claim 1, wherein the base resin is a siloxane-epoxy-based compound.

5. The window of claim 1, wherein the siloxane functionalized polyol comprises a caprolactone polyol.

6. The window of claim 1, wherein the photo initiator comprises at least one of an iodine salt, a sulfonium salt, a tropylium salt, an acetophenone-based compound, a sulfonium-based compound, a benzophenone-based compound, or an organic halide.

7. The window of claim 1, wherein the sensitizer is a thioxanthone-based compound.

8. The window of claim 1, wherein the cover layer has a modulus of about 500 Mpa to about 1.5 Gpa.

9. The window of claim 1, wherein the window further comprises a base layer below the cover layer, and comprising a polyethylene terephthalate film.

10. The window of claim 9, wherein the base layer has a thickness of about 20 μm to about 50 μm.

11. The window of claim 1, wherein the window further comprises:
a protecting layer above the cover layer; and
a protective adhesion layer between the protecting layer and the cover layer.

12. The window of claim 1, wherein the window further comprises a functional layer above the cover layer, comprising a fluorine-containing compound, and having a thickness of about 10 μm or less.

13. A display device comprising:
a display module; and
a window above the display module, and comprising a cover layer, the cover layer comprising:
a base resin comprising at least one of a siloxane-epoxy-based compound, an epoxy (meth)acrylate-based compound, or a urethane (meth)acrylate-based compound;
a siloxane functionalized polyol;
a diglycidyl ether compound;
a photo initiator; and
a sensitizer.

14. The display device of claim 13, wherein the window further comprises a base layer between the display module and the cover layer, and comprising a polymer film, and
wherein the cover layer is directly on the base layer.

15. The display device of claim 14, further comprising a window adhesion layer between the display module and the window,
wherein the base layer is directly on the window adhesion layer.

16. The display device of claim 13, wherein the display module comprises:
a base substrate;
a circuit layer above the base substrate;
a light-emitting element layer above the circuit layer;
an encapsulation layer above the light-emitting element layer; and
an optical layer above the encapsulation layer, and comprising a polarizing layer or color filter layer.

17. The display device of claim 16, wherein the cover layer is directly on the optical layer.

18. The display device of claim 16, further comprising a window adhesion layer between the optical layer and the cover layer, wherein the cover layer is directly on the window adhesion layer.

19. The display device of claim 13, further comprising at least one folding part that is folded with respect to a folding axis extending to one direction.

20. An electronic device providing an image,
the electronic device comprising:
a display module; and
a window above the display module, and comprising a cover layer, the cover layer comprising:
a base resin comprising at least one of a siloxane-epoxy-based compound, an epoxy (meth)acrylate-based compound, or a urethane (meth)acrylate-based compound;
a siloxane functionalized polyol;
a diglycidyl ether compound;
a photo initiator; and
a sensitizer.
